(19) United States
(12) Patent Application Publication
(10) Pub. No.: US 2007/0120894 A1
(43) Pub. Date: May 31, 2007

(54) MICROINJECTORS

(75) Inventors: Chung-Cheng Chou, Taoyuan County (TW); Shang-Shi Wu, Chiai (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/563,652

(22) Filed: Nov. 27, 2006

(30) Foreign Application Priority Data
Nov. 30, 2005 (TW) TW94142042

(51) Int. Cl. B41J 2/05

(52) U.S. Cl. 347/61

(57) ABSTRACT

Microinjectors are provided. A microinjector includes a substrate, a manifold formed on the substrate, and at least a jet unit. The jet unit includes a nozzle layer connected to the substrate, a nozzle disposed on the nozzle layer, a reservoir, a first heater disposed on a first side of the nozzle and a second heater disposed on a second side of the nozzle. The reservoir is formed between the nozzle layer and the substrate, connecting the nozzle and the manifold. Specifically, the first and second heaters are actuated by individual drive circuits, to heat the reservoir and eject a droplet through the nozzle.

### BACKGROUND OF THE INVENTION

1. Field of the Invention

The invention relates in general to microinjectors and in particular to microinjectors controlling ejection directions of droplets.

2. Description of the Related Art

Microinjection technologies are widely applied to inkjet printers. Two primary inkjet technologies are thermal bubble and piezoelectric. As shown in FIG. 1, U.S. Pat. No. 6,588,878 B2 discloses a thermal bubble inkjet print head comprising a plurality of jet units E. Ejection direction, speed and quantity of ink droplet depend on profiles, dimensions and arrangements of the reservoir 14, the nozzle 18 and the heaters 20 of every jet unit E.

In FIG. 1, each jet unit E comprises two heaters 20 electrically connected in series. When the series heaters 20 are actuated, two bubbles are generated correspondingly, to eject fluid F through the nozzle 18 and generate a droplet D flying along Z axis. As the heaters 20 are symmetrically disposed on opposite sides of the nozzle 18, droplet D flies along Z axis, substantially perpendicular to nozzle layer 12.

According to prior art of U.S. Pat. No. 6,588,878 B2, structure of the jet unit E dominates fluid ejection through the nozzle 18. When the jet unit E is determined, trajectory of droplet is invariable according thereto. Here, conventional droplet ejection trajectory is along Z axis, substantially perpendicular to nozzle layer 12.

### BRIEF SUMMARY OF THE INVENTION

Microinjectors are provided. A microinjector includes a substrate, a manifold formed on the substrate, and at least a jet unit. The jet unit includes a nozzle layer connected to the substrate, a nozzle disposed on the nozzle layer, a reservoir, a first heater disposed on a first side of the nozzle and a second heater disposed on a second side of the nozzle. The reservoir is formed between the nozzle layer and the substrate, connecting the nozzle and the manifold. Specifically, the first and second heaters are actuated by individual drive circuits, to heat the reservoir and eject droplets through the nozzle.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional thermal bubble inkjet print head;

FIG. 2 is a perspective diagram of an embodiment of a microinjector with a first heater disposed on a side of a nozzle;

FIG. 3 is a perspective diagram of an embodiment of a microinjector with a first heater and a second heater disposed on adjacent sides of a nozzle;

FIGS. 4A, 4B and 4C are perspective diagrams illustrating contact positions of droplets on a medium;

FIGS. 5A and 5B are perspective diagrams of an embodiment of a microinjector comprising a plurality of jet units, each unit comprising a first heater and a second heater disposed on adjacent sides of a nozzle;

FIGS. 6A and 6B are perspective diagrams of an embodiment of a microinjector comprising a plurality of jet units, each jet unit comprising a first heater and a second heater disposed on opposite sides of a nozzle; and

FIG. 7 is a perspective diagram of an embodiment of a microinjector with four heaters surrounding a nozzle.

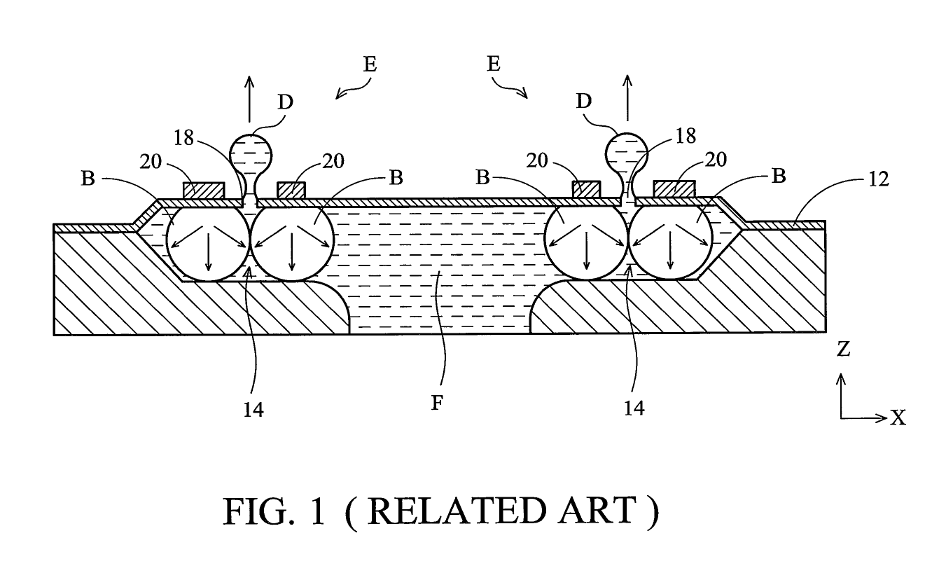

### DETAILED DESCRIPTION OF THE INVENTION

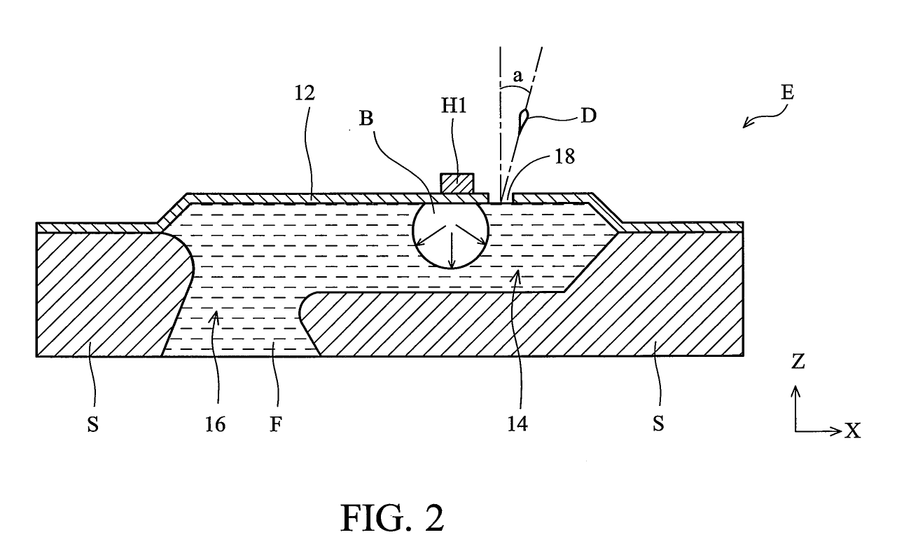

An embodiment of a microinjector, such as a monolithic inkjet chip, comprises a substrate S, a manifold 16 formed on the substrate S and a plurality of jet units E, as shown in FIG. 2. Each of the jet units E comprises a nozzle layer 12 disposed on the substrate S, a reservoir 14 formed between the nozzle layer 12 and the substrate S, and a first heater H1 disposed on an outer surface of the nozzle layer 12. Specifically, the reservoir 14 connects the manifold 16 and a nozzle 18 on the nozzle layer 12.

As shown in FIG. 2, the first heater H1 is disposed close to the nozzle 18 to heat the reservoir 14, and a bubble is thereby generated to eject a droplet D through the nozzle 18. Here, since the first heater H1 is asymmetrically disposed on a first side of the nozzle 18, ejection direction of the droplet D deviates from Z axis by an angle a, as shown in FIG. 2. In some embodiments, a plurality of heaters can be disposed on different aspects around the nozzle 18, to alter ejection trajectory of droplet D.

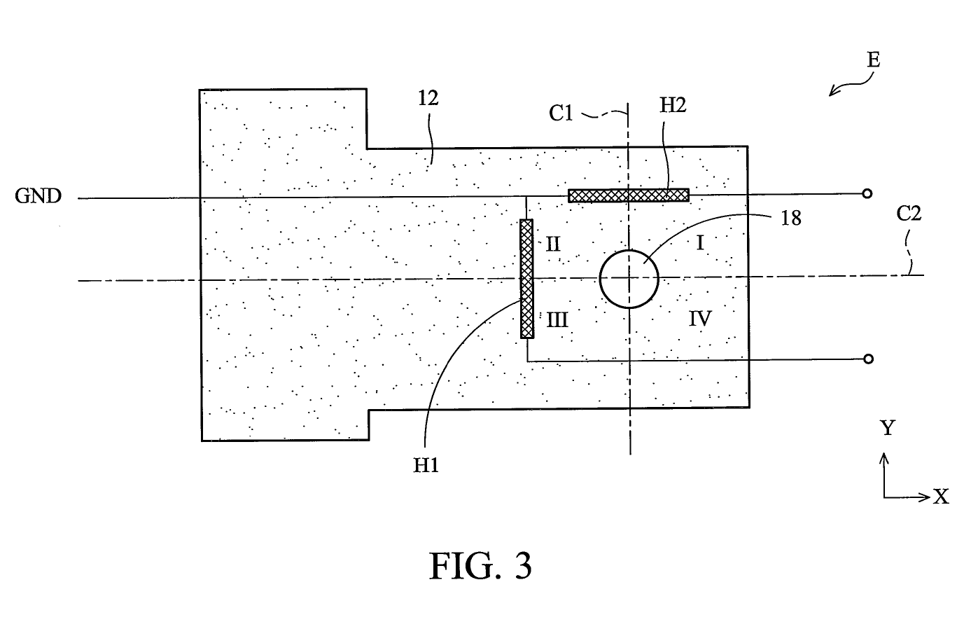

Referring to FIG. 3, another embodiment of a microinjector comprises a first heater H1 and a second heater H2 connected to individual drive circuits (not shown), disposed on first and second sides (left and upper sides) of the nozzle 18. In this embodiment, the first and second heaters H1 and H2 are rectangular, extending along Y axis and X axis, respectively.

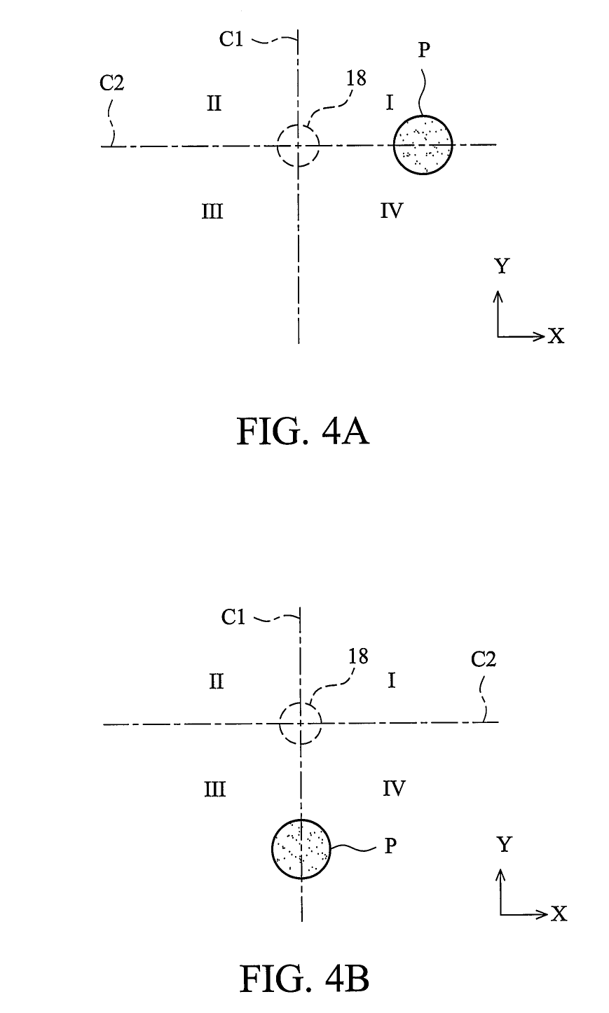

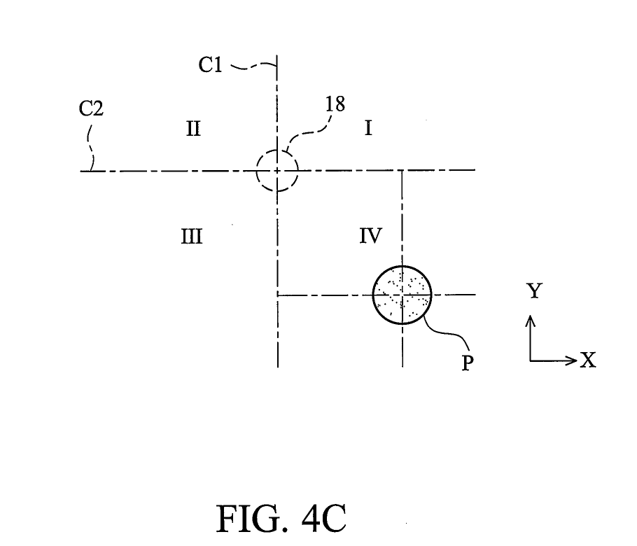

FIG. 4A illustrates a contact position P on a medium of a droplet when the first heater H1 in FIG. 3 is actuated, and FIG. 4B illustrates a contact position P of a droplet when the second heater H2 in FIG. 3 is actuated. Here, since the first and second heaters H1 and H2 are disposed on adjacent sides (left and upper sides) of the nozzle 18 and actuated by independent drive circuits, when only the first heater H1 is actuated to heat the reservoir 14, the contact position P deviates from a center axis C1 of the nozzle 18 and located in quadrant I or IV, as shown in FIG. 4A. Similarly, when only the second heater H2 is actuated to heat the reservoir 14, contact position P deviates from another center axis C2 and located in quadrant III or IV, as shown in FIG. 4B. When both of the first and second heaters H1 and H2 are actuated to heat the reservoir 14, as shown in FIG. 4C, contact position P deviates from the center axes C1 and C2 and located in quadrant IV.

According to the embodiment, rectangular aspect ratios of the first and second heaters H1 and H2 can be appropriately designed, such as a square, to alter direction, quantity and speed of droplet ejection, wherein profiles of the first and second heaters H1 and H2 can be the same or different.

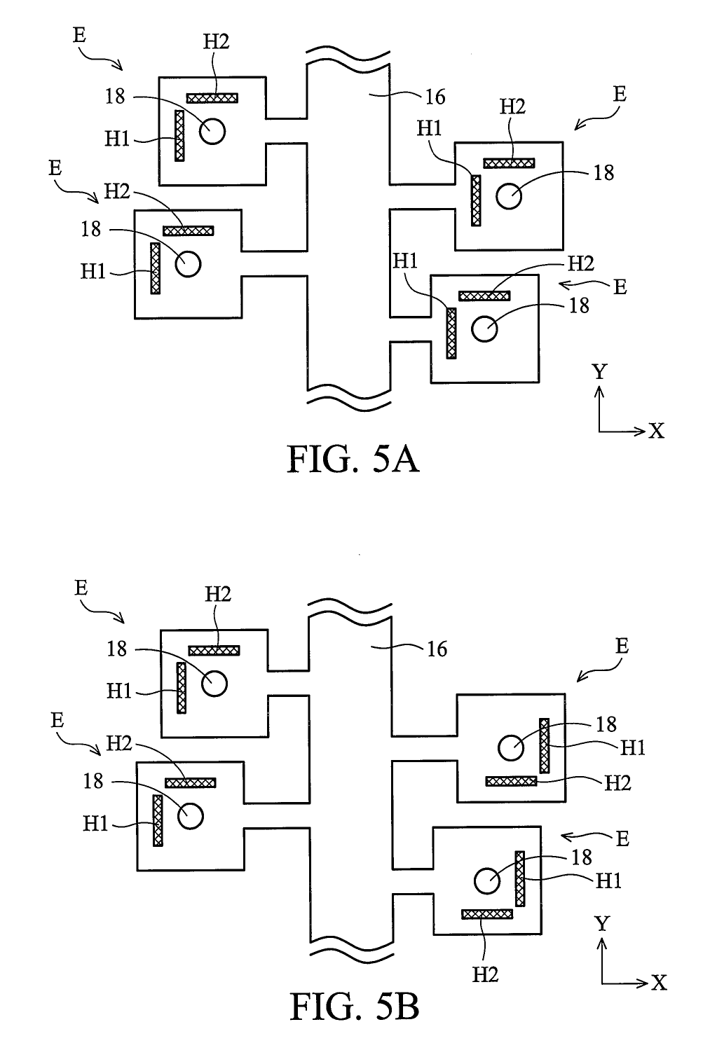

Referring to FIGS. 5A and 5B, a microinjector comprises a manifold 16 and a plurality of jet units E, wherein fluid flows through the manifold 16 to the jet units E and exits the nozzles 18. In this embodiment, each of the jet units E comprises a first heater H1 and a second heater H2 disposed on adjacent sides of the nozzle 18.

In FIG. 5A, the first and second heaters H1 and H2 in every jet unit E are disposed on left and upper sides of the nozzle 18. As the first and second heaters H1 and H2 are actuated by individual drive circuits (not shown), ejection of droplet deviates rightward or downward from the nozzle 18.

Referring to FIG. 5B, each of the jet units E on the left side of the manifold 16 comprises a first heater H1 and a second heater H2 respectively disposed on left and upper sides of the nozzle 18. Correspondingly, each of the jet units E on the right side of the manifold 16 comprises a first heater H1 and a second heater H2 respectively disposed on right and lower sides of the nozzle 18. Comparing FIG. 5A with FIG. 5B, the microinjector in FIG. 5B provides higher density of drop points on a medium. As the first and second heaters H1 and H2 in FIGS. 5A and 5B are actuated by individual drive circuits, rejection trajectories of droplets deviates from the nozzle 18 in X or Y directions, facilitating flexible and high printing efficiency of an inkjet printer.

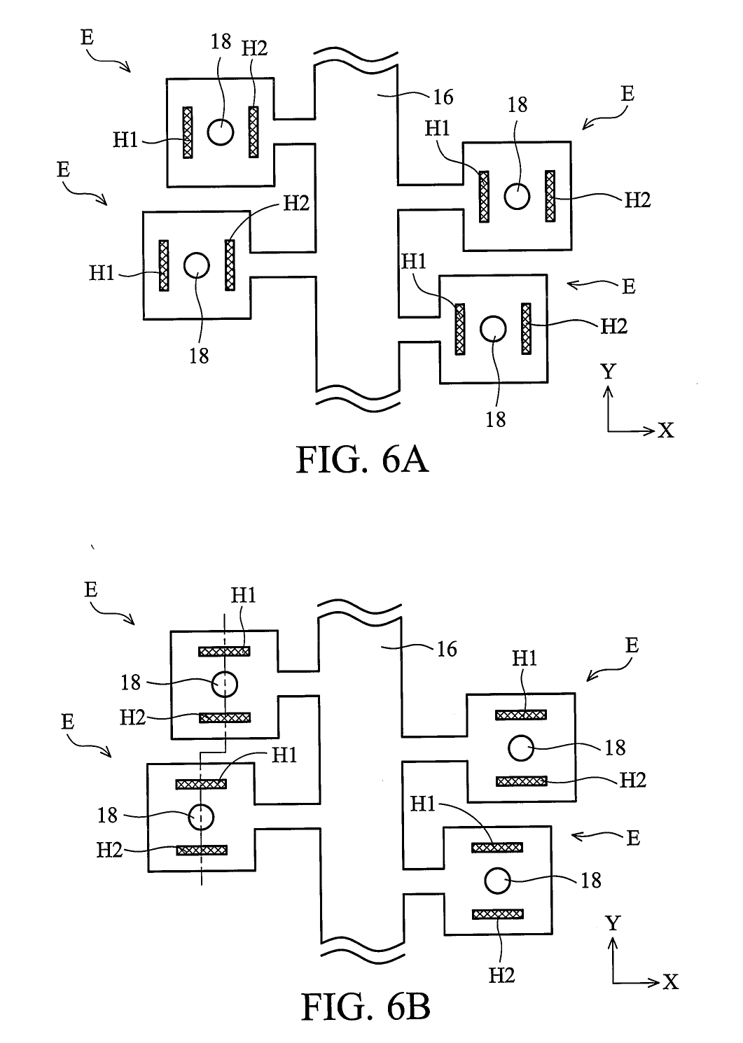

Referring to FIGS. 6A and 6B, the first and second heaters H1 and H2 can also be disposed on opposite sides of the nozzle 18 within every jet unit E. As shown in FIG. 6A, the first and second heaters H1 and H2 are disposed on left and right sides of the nozzle 18, to deviate contact positions of ejected droplets from the nozzle 18 along X axis. Similarly, as shown in FIG. 6B, the first and second heaters H1 and H2 are disposed on upper and lower sides of the nozzle 18, to deviate contact positions of ejected droplets from the nozzle 18 along Y axis.

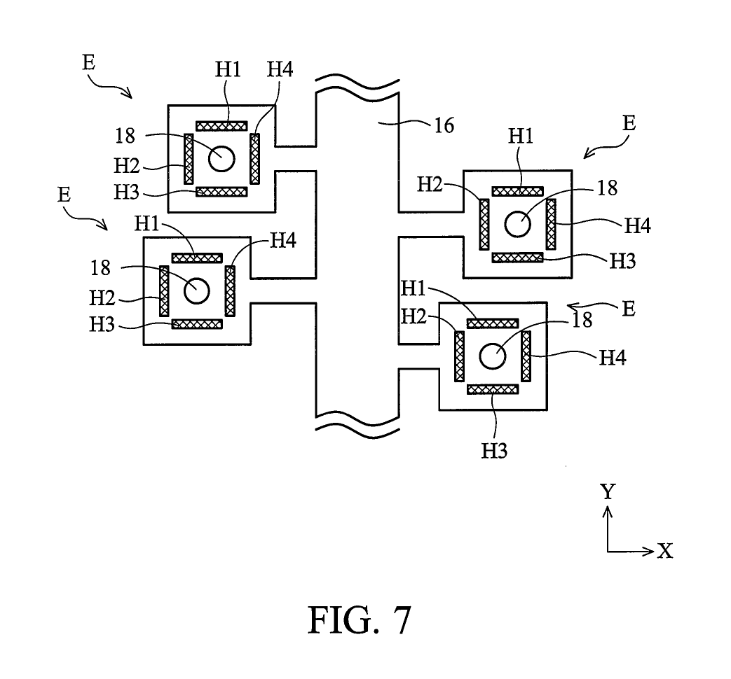

Referring to FIG. 7, another embodiment of the nozzle 18 is surrounded by a first heater H1, a second heater H2, a third heater H3 and a fourth heater H4, wherein profiles of the first, second third and fourth heaters H1, H2, H3 and H4 can be the same or different, such as squares or rectangles. Specifically, the first, second third and fourth heaters H1, H2, H3 and H4 are connected to individual drive circuits, to deviate contact positions of ejected droplets from the nozzle 18 along X axis or Y axis. In this embodiment, a control unit electrically connects every heater of the jet units E, to simultaneously control droplet ejection through every nozzles 18. Thus, direction, quantity, speed, and contact position of ejected droplets can be appropriately altered, capable of high density printing and gray scale of high intensity resolution.

Microinjectors capable of controlling ejection direction, quantity and speed are provided according to the embodiments. The microinjectors can be applied in inkjet printers, micro jet propulsion system and Biomedical engineering, such as fuel/air ratio control systems and medical injections.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A microinjector, comprising:
a substrate;
a manifold formed on the substrate;
a jet unit, comprising:
a nozzle layer connected to the substrate, comprising a nozzle;
a reservoir formed between the nozzle layer and the substrate, connecting the nozzle and the manifold;
a first heater, disposed on a first side of the nozzle; and
a second heater, disposed on a second side of the nozzle, wherein the first and second heaters are actuated by individual drive circuits, heating the reservoir to eject a droplet through the nozzle.

2. The microinjector as claimed in claim 1, wherein the droplet is ejected in a direction deviating from a center axis of the nozzle.

3. The microinjector as claimed in claim 1, wherein the first side is opposite the second side.

4. The microinjector as claimed in claim 1, wherein the first side is adjacent to the second side.

5. The microinjector as claimed in claim 1, further comprising a third heater and a fourth heater, wherein the first, second, third and fourth heaters surround the nozzle and are actuated by individual drive circuits, to eject the droplet through the nozzle.

6. The microinjector as claimed in claim 1, wherein the microinjector is formed by a monolithic structure.

7. The microinjector as claimed in claim 1, wherein the first and second heaters have different profiles.

8. The microinjector as claimed in claim 1, wherein the first and second heaters are substantially rectangular.

9. The microinjector as claimed in claim 8, wherein the first heater extends substantially along the first side.

10. The microinjector as claimed in claim 8, wherein the first heater is square.

11. A microinjector, comprising:
a substrate;
a manifold formed on the substrate;
a plurality of jet units, each comprising:
a nozzle layer connected to the substrate, comprising a nozzle;
a reservoir formed between the nozzle layer and the substrate, connecting the nozzle and the manifold;
a first heater, disposed on a first side of the nozzle; and
a second heater, disposed on a second side of the nozzle, wherein the first and second heaters are connected to individual drive circuits, heating the reservoir to eject a droplet through the nozzle.

12. The microinjector as claimed in claim 11, wherein the droplet is ejected in a direction deviating from a center axis of the nozzle.

13. The microinjector as claimed in claim 11, wherein the first side is opposite the second side.

14. The microinjector as claimed in claim 11, wherein the first side is adjacent to the second side.

15. The microinjector as claimed in claim 11, further comprising a third heater and a fourth heater, wherein the first, second, third and fourth heaters surround the nozzle and are actuated by individual drive circuits, to eject the droplet through the nozzle.

16. The microinjector as claimed in claim 11, wherein the microinjector is formed by a monolithic structure.

17. The microinjector as claimed in claim 11, wherein the first and second heaters have different profiles.

18. The microinjector as claimed in claim 11, wherein the first and second heaters are substantially rectangular.

19. The microinjector as claimed in claim 18, wherein the first heater extends substantially along the first side.

20. The microinjector as claimed in claim 18, wherein the first heater is square.
